(19) United States
(12) Patent Application Publication
(10) Pub. No.: US 2018/0297523 A1
(43) Pub. Date: Oct. 18, 2018

(54) REAR VIEW DISPLAY ADJUSTABLE VIRTUAL CAMERA VIEW POINT SYSTEM AND METHOD

(71) Applicant: Panasonic Automotive Systems Company of America, Division of Panasonic Corporation of North America, PEACHTREE CITY, GA (US)

(72) Inventor: MICHAEL DEAN TSCHIRHART, ANN ARBOR, MI (US)

(73) Assignee: Panasonic Automotive Systems Company of America, Division of Panasonic Corporation of North America

(21) Appl. No.: 15/950,525

(22) Filed: Apr. 11, 2018

Related U.S. Application Data
(60) Provisional application No. 62/485,672, filed on Apr. 14, 2017.

(51) Int. Cl. B60R 1/00; H04N 5/232; H04N 5/262

(52) U.S. Cl. CPC B60R 1/00; H04N 5/23216; H04N 5/2628; B60R 2300/8046; B60R 2300/306; B60R 2300/602; B60R 2300/8066; B60R 2300/108

(57) ABSTRACT

A motor vehicle includes a display screen viewable by a driver of the motor vehicle. A rearview camera is mounted on a rear end of the motor vehicle and captures images of a scene behind the motor vehicle. An electronic processor is communicatively coupled to the display screen and to the rearview camera. The electronic processor processes the images captured by the camera to thereby present on the display screen video content having a virtual camera mount location disposed between the display screen and the rearview camera.

### CROSS-REFERENCE TO RELATED APPLICATION

This application claims benefit of U.S. Provisional Application No. 62/485,672 filed on Apr. 14, 2017, which the disclosure of which is hereby incorporated by reference in its entirety for all purposes.

### BACKGROUND OF THE INVENTION

### 1. Field of the Invention

The present invention relates to rearview displays in a motor vehicle, and, more particularly, to display-based mirror substitute technologies.

### 2. Description of the Related Art

Display-based mirror substitute technologies like intelligent rearview mirror system (IRMS) enable a range of desirable features and functions to the driver. However, early testing reveals that the camera view point at the physical camera position at the rear of the vehicle is associated with negative impressions based in part on the virtual gap between the view point expected of a traditional rearview mirror and the provided view point of the camera at the rear of the vehicle. Most systems employ raw or mildly processed visual display of the rearward view from the rearview camera without consideration of these issues.

FIG. 1 illustrates the viewpoint or field of view of a driver 10 of a vehicle 12 in a rearview mirror 14. FIG. 2 illustrates the viewpoint or field of view of a driver 210 of a vehicle 212 in a rearview display 214 as captured by a rearview camera 216. A virtual gap 218 between the view point expected of rearview mirror 214 and the provided view point of the camera 216 at the rear of vehicle 212 typically causes the driver to be dissatisfied with the rearview display.

### SUMMARY OF THE INVENTION

The invention may solve the above problem by enabling the virtual distance or gap between the expected viewpoint of a traditional rearview mirror and the viewpoint at the rear of the vehicle to be reduced to a point that satisfies the viewer. The present invention may provide display-based alternatives to the traditional rear-view mirror (e.g., IRMS). The invention may provide a more natural and desirable functionality to display-based mirror substitute technologies.

The invention may provide a dynamically adjustable virtual camera view point through the use of image processing. According to the invention, image processing is employed to adjust the apparent camera position (view point) along the longitudinal axis of the vehicle within a certain range according to user preference. For example, the virtual camera view point can be changed so that the position is closer to (or the same as) the normal view point for a traditional rearview mirror system.

In one embodiment, the present invention comprises a motor vehicle including a display screen viewable by a driver of the motor vehicle. A rearview camera is mounted on a rear end of the motor vehicle and captures images of a scene behind the motor vehicle. An electronic processor is communicatively coupled to the display screen and to the rearview camera. The electronic processor processes the images captured by the camera to thereby present on the display screen video content having a virtual camera mount location disposed between the display screen and the rearview camera. The image configuration enabled by the invention emulates characteristics that could be achieved by physically moving the camera position (in the most basic implementation). Such adjustability can improve driver orientation within the visual field presented by the system.

In another embodiment, the present invention comprises a motor vehicle including a display screen viewable by a driver of the motor vehicle. A rearview camera captures images of a scene behind the motor vehicle. A user interface includes a control device receiving inputs from the driver. An electronic processor is communicatively coupled to the display screen, the rearview camera, and the control device. The electronic processor processes the images captured by the camera to thereby present on the display screen video content having a virtual camera mount location disposed between the display screen and the rearview camera. The electronic processor responds to inputs from the driver received from the control device by moving the virtual camera mount location. The moving of the virtual camera mount location includes changing the processing of the images captured by the camera.

In yet another embodiment, the present invention comprises a motor vehicle including a display screen viewable by a driver of the motor vehicle. A rearview camera captures images of a scene behind the motor vehicle. An electronic processor is communicatively coupled to the display screen and to the rearview camera. The electronic processor processes the images captured by the camera to thereby present on the display screen a digital re-mapping of a central portion of the images captured by the camera such that an outer portion of the images captured by the camera are omitted from presentation on the display screen.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is an overhead schematic diagram of the view seen by a driver in a rearview mirror of the prior art.

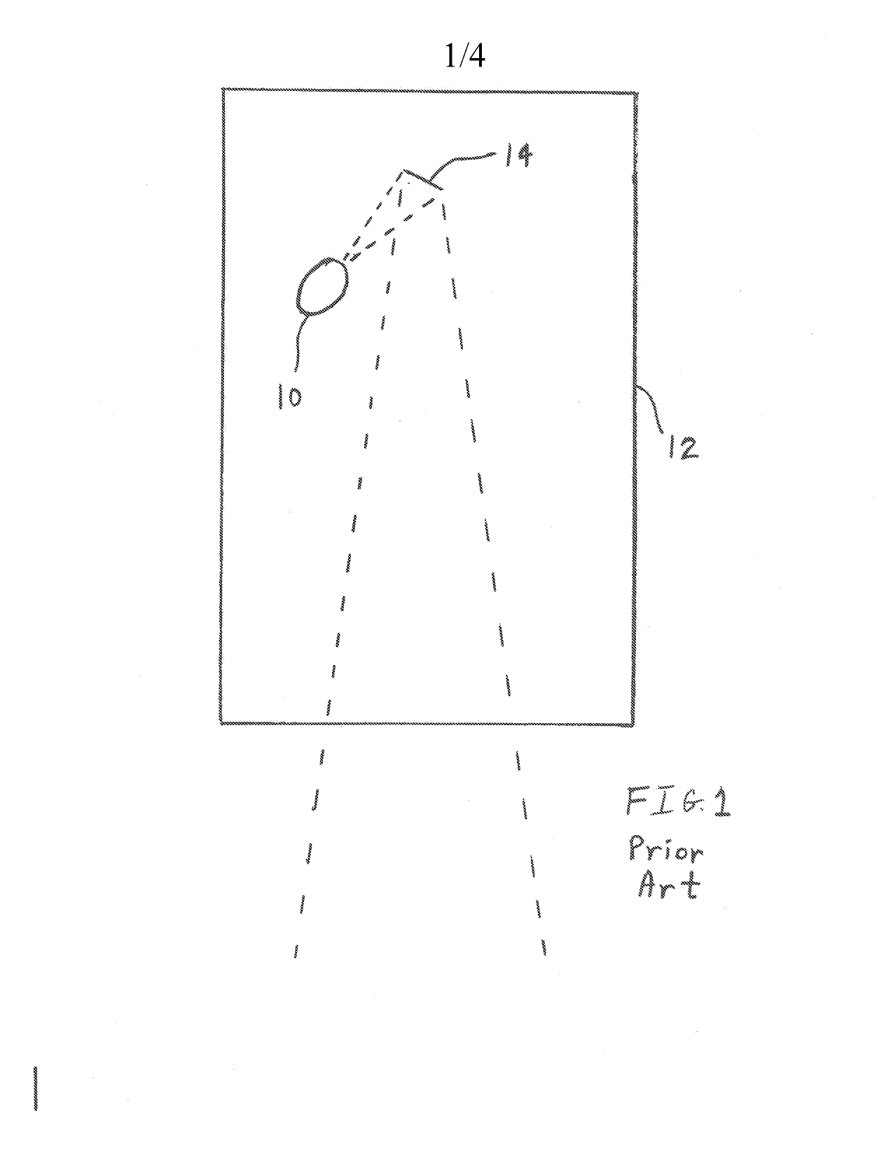

FIG. 2 is an overhead schematic diagram of the view seen by a driver provided by a rearview camera of the prior art.

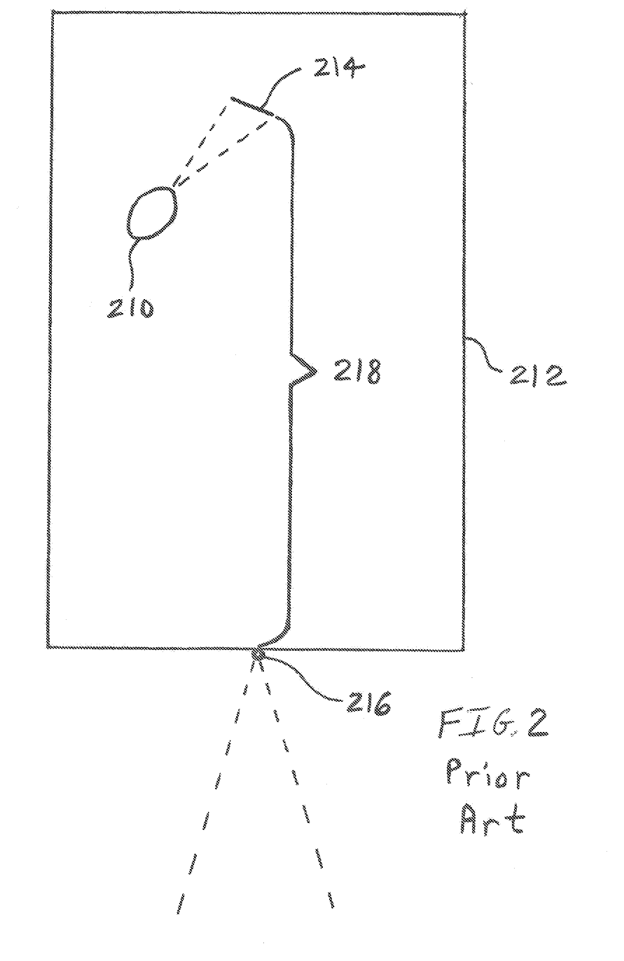

FIG. 3 is a block diagram of one embodiment of a rearview display arrangement of the present invention.

FIG. 4 is an overhead schematic diagram of the view seen by a driver provided by the rearview display arrangement of FIG. 3.

### DETAILED DESCRIPTION OF DRAWINGS

The embodiments hereinafter disclosed are not intended to be exhaustive or limit the invention to the precise forms disclosed in the following description. Rather the embodiments are chosen and described so that others skilled in the art may utilize its teachings.

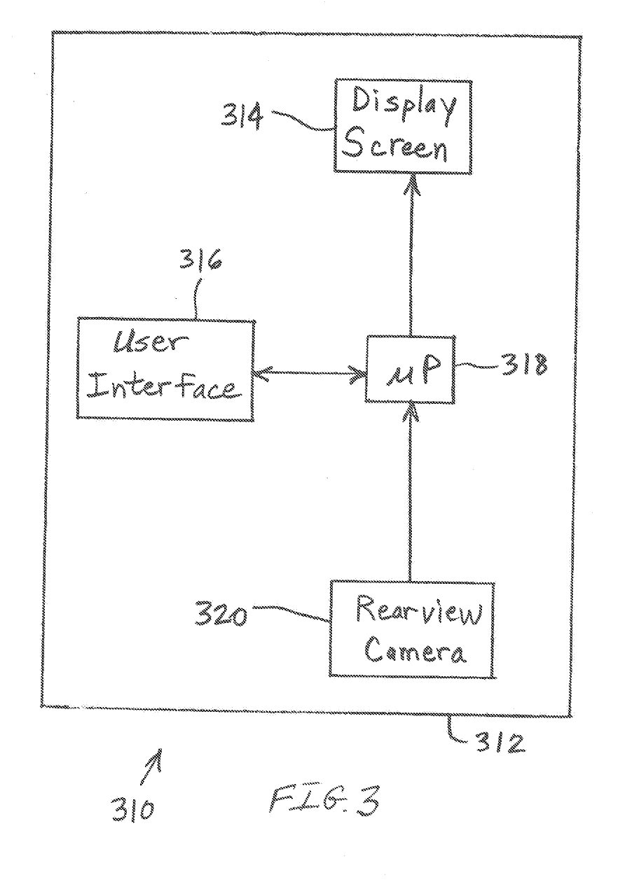

FIG. 3 illustrates one embodiment of a rearview display arrangement 310 of the present invention for a motor vehicle 312, including a rearview display screen 314, a user interface 316, an electronic processor 318, and a rearview camera 320. Processor 318 may receive the images captured by camera 320 and present mirror images of the captured images on display screen 314. Mirror images of the captured image may be presented in order to emulate the view that a driver would see in a conventional mirror.

Rearview camera 320 may be attached to a rear end of vehicle 312, and may capture images of a scene behind the vehicle. Rearview camera 320 may have a field of view that is larger than the field of view of a conventional rearview mirror. For example, rearview camera 320 may be a hemispherical camera having a hemispherical field of view. However, processor 318 may present only a central portion of the captured image on display screen 314. Processor 318 may re-map the image for presentation on display screen 314 in order to remove any distortion created by a wide angle or hemispherical lens of camera 320.

User interface 316 may include a dial or rocker switch, for example, by which the driver/user can adjust the size of the central portion of the captured image that processor 318 presents on display screen 314. For example, if the user thinks that the field of view presented on display screen 314 is too narrow, and is not as wide as the field of view typically provided by a conventional rearview mirror, then the user may turn the dial or move the rocker switch on user interface 316 to thereby broaden the field of view presented on display screen 314. Conversely, if the user thinks that the field of view presented on display screen 314 is too broad, then the user may turn the dial or move the rocker switch on user interface 316 in the opposite direction to thereby narrow the field of view presented on display screen 314. Alternatively, user interface 316 may include a microphone into which the user may speak commands regarding broadening and/or narrowing the field of view presented on display screen 314.

In response to receiving a resultant signal from user interface 316, processor 318 may enlarge or reduce the portion of the captured images that are presented on display screen 314. This enlarging or reducing of the portion of the captured images may include optical or digital zooming out or zooming in on the captured images. Regardless of the determined size of the portion of the captured images that are presented on screen 314, processor 318 may perform digital re-mapping of the image for presentation in order to remove distortions from the wide angle or hemispherical lens.

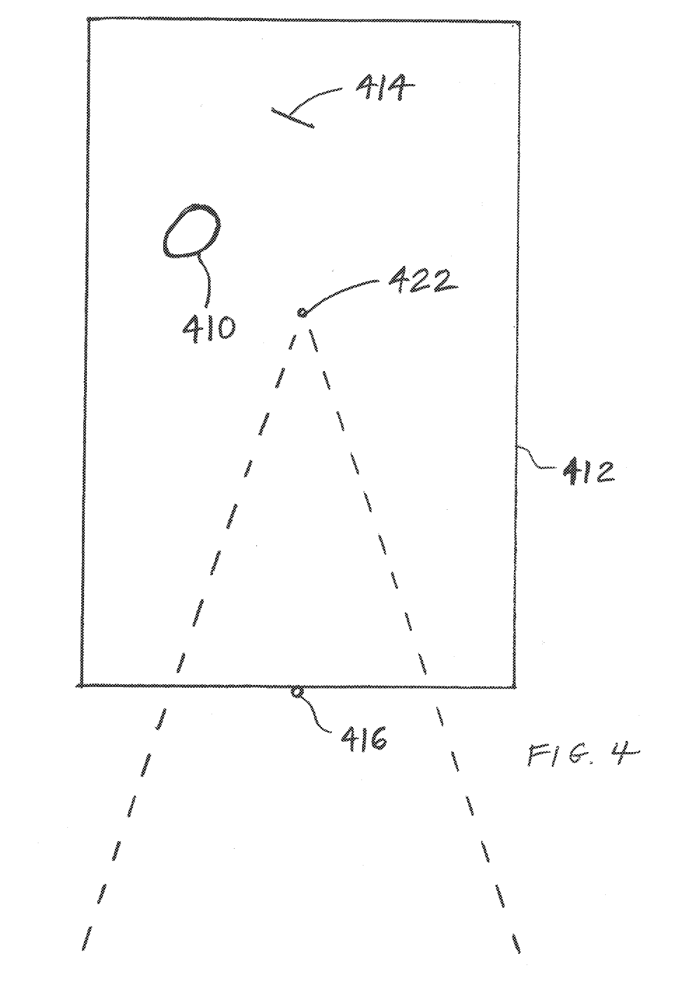

In one embodiment, the size of the portion of the captured image that is presented is adjustable between a minimum portion that approximately corresponds to a field of view provided by a conventional IRMS camera attached to a rear end of a vehicle, and a maximum portion that approximately corresponds to a field of view provided by a conventional rearview mirror. FIG. 4 illustrates the driver-adjustable viewpoint or field of view of a driver 410 of a vehicle 412 in a rearview display screen 414 as captured by a rearview camera 416. More particularly, FIG. 4 illustrates the field of view from a virtual camera mount point 422 at one user setting between the minimum portion setting and the maximum portion setting. As an alternative to the techniques disclosed above, the effect of changing the virtual camera mount location may be achieved within the scope of the invention by blending or otherwise merging images captured by two or more cameras.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A motor vehicle comprising:
a display screen viewable by a driver of the motor vehicle;
a rearview camera mounted on a rear end of the motor vehicle and configured to capture images of a scene behind the motor vehicle; and
an electronic processor communicatively coupled to the display screen and the rearview camera, the electronic processor being configured to process the images captured by the camera to thereby present on the display screen video content having a virtual camera mount location disposed between the display screen and the rearview camera.

2. The motor vehicle of claim 1, wherein the rearview camera comprises a wide-angle camera.

3. The motor vehicle of claim 1, further comprising a control device communicatively coupled to the electronic processor and configured to receive inputs from the driver, the electronic processor being configured to respond to inputs from the driver received from the control device by moving a virtual camera mount location.

4. The motor vehicle of claim 3, wherein the moving of the virtual camera mount location includes changing a size of a central portion of the captured images that is presented on the display screen.

5. The motor vehicle of claim 4, wherein the rearview camera comprises a wide-angle camera, and wherein the moving of the virtual camera mount location includes digitally re-mapping the central portion of the captured images that is presented on the display screen.

6. The motor vehicle of claim 3, wherein the moving of the virtual camera mount location includes moving the virtual camera mount location to a location disposed between the display screen and the rearview camera.

7. The motor vehicle of claim 1 wherein the display screen is disposed approximately at a midpoint of a top edge of a windshield of the motor vehicle.

8. A motor vehicle comprising:
a display screen viewable by a driver of the motor vehicle;
a rearview camera configured to capture images of a scene behind the motor vehicle;
a user interface including a control device configured to receive inputs from the driver; and
an electronic processor communicatively coupled to the display screen, the rearview camera, and the control device, the electronic processor being configured to:
process the images captured by the camera to thereby present on the display screen video content having a virtual camera mount location disposed between the display screen and the rearview camera; and
respond to inputs from the driver received from the control device by moving the virtual camera mount location, the moving of the virtual camera mount location including changing the processing of the images captured by the camera.

9. The motor vehicle of claim 8, wherein the rearview camera comprises a hemispherical camera.

10. The motor vehicle of claim 8, wherein the moving of the virtual camera mount location includes changing a size of a central portion of the captured images that is presented on the display screen.

11. The motor vehicle of claim 10, wherein the moving of the virtual camera mount location includes digitally re-mapping the central portion of the captured images that is presented on the display screen.

12. The motor vehicle of claim 8, wherein the moving of the virtual camera mount location includes moving the virtual camera mount location to a location disposed between the display screen and the rearview camera.

13. The motor vehicle of claim 8 wherein the display screen is disposed approximately at a midpoint of a top edge of a windshield of the motor vehicle.

14. The motor vehicle of claim 8 wherein the rearview camera is mounted on a rear end of the motor vehicle.

15. A motor vehicle comprising:
a display screen viewable by a driver of the motor vehicle;
a rearview camera configured to capture images of a scene behind the motor vehicle; and
an electronic processor communicatively coupled to the display screen and to the rearview camera, the electronic processor being configured to process the images captured by the camera to thereby present on the display screen a digital re-mapping of a central portion of the images captured by the camera such that an outer portion of the images captured by the camera are omitted from presentation on the display screen.

16. The motor vehicle of claim 15 wherein the electronic processor is configured to process the images captured by the camera to thereby move a virtual camera mount location between the display screen and the rearview camera.

17. The motor vehicle of claim 15, wherein the rearview camera comprises a hemispherical camera.

18. The motor vehicle of claim 15 wherein the display screen is disposed approximately at a midpoint of a top edge of a windshield of the motor vehicle.

19. The motor vehicle of claim 15 wherein the rearview camera is mounted on a rear end of the motor vehicle.

20. The motor vehicle of claim 15, further comprising a control device communicatively coupled to the electronic processor and configured to receive inputs from the driver, the electronic processor being configured to respond to inputs from the driver received from the control device by moving a virtual camera mount location.
